(19) United States
(12) Patent Application Publication
(10) Pub. No.: US 2020/0216095 A1
(43) Pub. Date: Jul. 9, 2020

(54) VEHICLE DRIVING ASSISTANCE APPARATUS

(71) Applicant: DENSO CORPORATION, Kariya-city (JP)

(72) Inventors: Shin ISOZAKI, Kariya-city (JP); Ichiro YOSHIDA, Kariya-city (JP)

(73) Assignees: DENSO CORPORATION, Kariya-city, Aichi-pref. (JP); DENSO CORPORATION, Kariya-city, Aichi-pref. (JP)

(21) Appl. No.: 16/822,603

(22) Filed: Mar. 18, 2020

Related U.S. Application Data
(63) Continuation of application No. PCT/JP2018/031750, filed on Aug. 28, 2018.

(30) Foreign Application Priority Data
Oct. 12, 2017 (JP) 2017-198467

(51) Int. Cl. B60W 60/00; G08B 21/06; H04W 4/46; G06K 9/00; B60W 50/14; B60W 10/30; B60N 2/56

(52) U.S. Cl. CPC B60W 60/0016; G08B 21/06; H04W 4/46; G06K 9/00845; B60W 50/14; B60W 2420/42; B60N 2/56; B60W 60/0051; B60W 2050/143; B60W 2050/146; B60W 2540/229; B60W 10/30

(57) ABSTRACT

In a vehicle, a sleepiness degree of a driver is detected based on an eye opening degree and an eye opening time of an eye of the driver. A process corresponding to one of a plurality of levels of the detected sleepiness degree is selected and executed from among a plurality of processes to awaken the driver.

### CROSS REFERENCE TO RELATED APPLICATIONS

The present application is a continuation application of International Patent Application No. PCT/JP2018/031750 filed on Aug. 28, 2018, which designated the U.S. and claims the benefit of priority from Japanese Patent Application No. 2017-198467 filed on Oct. 12, 2017. The entire disclosures of all of the above applications are incorporated herein by reference.

### TECHNICAL FIELD

The present disclosure relates to a vehicle driving assistance apparatus.

### BACKGROUND

There is known a system that recognizes a driver's image captured with an in-vehicle camera, determines the driver's sleepiness, and generate a sound and vibration when the driver's sleepiness becomes strong, thereby encouraging awakening.

### SUMMARY

According to an example of the present disclosure, in a vehicle, a sleepiness degree of a driver may be detected based on an eye opening degree and an eye opening time of an eye of the driver. A process corresponding to one of a plurality of levels of the detected sleepiness degree may be selected and executed from among a plurality of processes to awaken the driver.

### BRIEF DESCRIPTION OF DRAWINGS

The objects, features and advantages of the present disclosure will become more apparent from the following detailed description made with reference to the accompanying drawings. In the drawings:

FIG. 1 is a block diagram of a vehicle system according to a first embodiment;

FIG. 2 is a flowchart of a control of detecting a sleepiness depth and a control executed according to the sleepiness depth;

FIG. 3 is a diagram showing definitions of sleepiness depth;

FIG. 4 is a diagram (part 1) showing a display example of a sleepiness warning advice;

FIG. 5 is a diagram (part 2) showing a display example of a sleepiness warning advice;

FIG. 6 is a diagram (part 3) showing a display example of a sleepiness warning advice;

FIG. 7 is a flowchart of a control of a first process;

FIG. 8 is a flowchart of a control of a second process;

FIG. 9 is a flowchart of a control of a third process; and

FIG. 10 is a diagram showing definitions of eye opening degrees according to a second embodiment.

### DETAILED DESCRIPTION

### First Embodiment

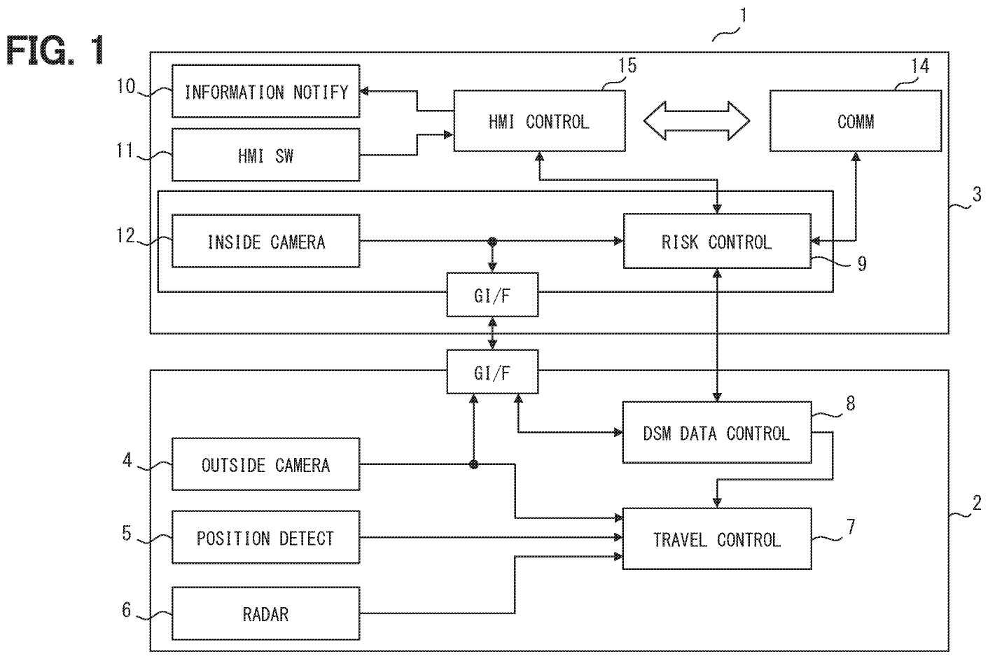

The following will describe a first embodiment of the present disclosure with reference to FIGS. 1 to 9. FIG. 1 is a block diagram showing an overall schematic configuration of a vehicle system 1 of the present embodiment. The vehicle system 1 may correspond to a vehicle driving assistance apparatus. The vehicle system 1 includes a vehicle travel control circuit 2 that controls traveling of the vehicle, and an in-vehicle information control circuit 3 that controls information communicated between various in-vehicle devices. Both control circuits 2 and 3 are connected with each other via a communication link as in FIG. 1.

The vehicle travel control circuit 2 includes a vehicle-outside camera 4, a position detector 5, a radar 6, a vehicle travel controller 7, and a DSM data controller 8, all of which are connected with each other via communication links as in FIG. 1.

The vehicle travel control circuit 2 includes one or more controllers, which may also be referred to as one or more processors. Functions provided by the vehicle travel control circuit 2 or the functions provided by each of the vehicle travel controller 7 and the DSM data controller 8 in the vehicle travel control circuit 2 may be implemented by such one or more controllers in the vehicle travel control circuit 2. Note that an individual one of the one or more controllers (or processors) may be configured by (i) a central processing unit (CPU) along with memory storing instructions executed by the CPU or (ii) hardware circuitry including an analog circuit and/or digital circuit with no CPU, or (iii) a combination of the CPU along with memory and the hardware circuitry.

The vehicle-outside camera 4 captures an image of the periphery of the vehicle and outputs the captured outside-vehicle image to the vehicle travel controller 7.

The position detector 5, which may also be referred to as a position measurement device 5, includes a GPS receiver or the like, detects the current position of the vehicle, and outputs the detected current position signal to the vehicle travel controller 7.

The radar 6 detects surrounding vehicles existing around the vehicle, and outputs information on the detected surrounding vehicles, that is, information specifying the position of the other surrounding vehicles, such as position information, distance information, angle information, and the like, to the vehicle travel controller 7.

The vehicle travel controller 7, which may also be referred to as a travel control device 7, receives the respective detection signals and the signal output from the DSM data controller 8, and functions as a car navigation device and functions as automatically controlling the vehicle by controlling the driving of the engine, brake, steering, etc. of the vehicle.

The DSM data controller 8, which may also be referred to as a DSM data processing unit 8, receives the image data from the vehicle-outside camera 4 and the instruction information from a risk controller 9 of the information control circuit 3, and outputs a driving switching signal to the vehicle travel controller 7.

The information control circuit 3 includes an information notification device 10, an HMI switch 11, a DSM vehicle-inside camera 12, a risk controller 9, a communicator 14, and an HMI controller 15, all of which are connected with each other via communication links as in FIG. 1.

The information control circuit 3 includes one or more controllers, which may also be referred to as one or more processors. Functions provided by the information control circuit 3 or the functions provided by each of the risk controller 9 and the HMI controller 15 in the information control circuit 3 may be implemented by such one or more controllers in the information control circuit 3. Note that an individual one of the one or more controllers (or processors) may be configured by (i) a central processing unit (CPU) along with memory storing instructions executed by the CPU or (ii) hardware circuitry including an analog circuit and/or digital circuit with no CPU, or (iii) a combination of the CPU along with memory and the hardware circuitry.

Furthermore, in the present embodiment, the vehicle travel control circuit 2 and the information control circuit 3 are provided to be separate from each other as in FIG. 1. There is no need to be limited thereto. That is, the vehicle travel control circuit 2 and the information control circuit 3 may provided to be integrated with each other as one control circuit including one or more controllers.

The information notification device 10, which may also be referred to as a display and speaker 10, is configured by, for example, a display, a sound output device (i.e., speaker), and the like, and is a device that displays data, messages, and the like received from the HMI controller 15 and outputs them by speech.

The HMI switch 11, which may also be referred to as an HMI manipulation unit 11, is a device manipulated by a user (i.e., an occupant), and configured by various input switches and a touch panel on the display screen. The manipulation result (i.e., a manipulation signal) is transmitted to the HMI controller 15.

The DSM vehicle-inside camera 12 has a function as a monitor for monitoring the state of the driver, that is, a DSM (driver status monitor), and a function as a camera for shooting the inside of the vehicle. The DSM information obtained by the DSM vehicle-inside camera 12 and the image data obtained by photographing the inside of the vehicle or the driver are transmitted to the risk controller 9. The DSM vehicle-inside camera 12 has a function as a driver monitor.

The risk controller 9, which also be referred to as a risk determination device 9, receives information from the DSM vehicle-inside camera 12, information from the DSM data controller 8, and information from the communicator 14. The risk controller 9 has a function of calculating, that is, detecting and determining the risk in driving the vehicle by the driver, specifically, the driver's sleepiness depth, based on the received information. In this case, the risk controller 9 has a function as a sleepiness depth calculator or detector or a sleepiness calculator or detector.

The communicator 14, which may also referred to as a transceiver 14 or a communication control device 14, has a function as a DCM (data communication module) and is configured by a communication device capable of performing vehicle-to-vehicle communication, road-to-vehicle communication, VICS communication, mobile phone network communication, and the like. The communicator 14 transmits the communication information obtained by the above various communications to the risk controller 9. Moreover, the communicator 14 transmits the information output from the risk controller 9 via the various communications. The HMI controller 15, which may also be referred to as an HMI control device 15, has a function of generating or controlling (i.e., editing) data for screen display or audio output, and transmits the generated or edited data to the information notification device 10.

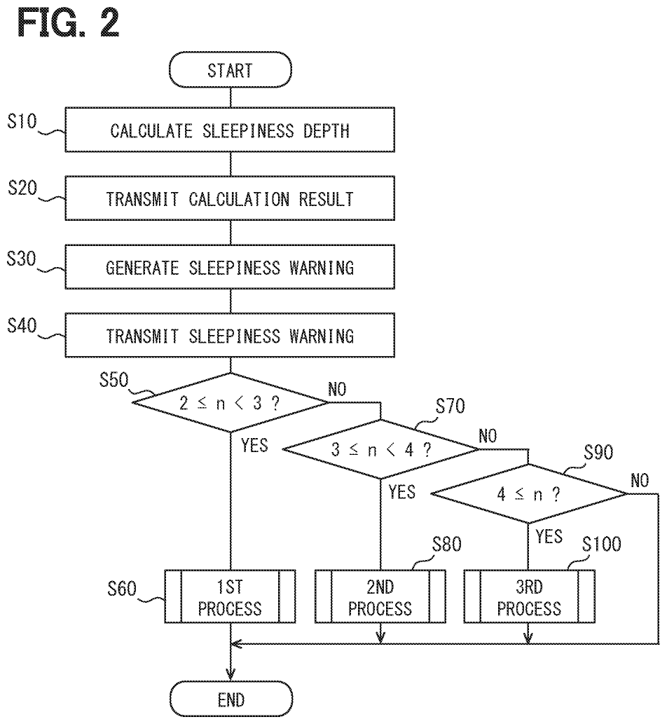

The following will describe an operation of the above configuration (i.e., detecting the sleepiness depth of the driver and controlling the execution according to the detected sleepiness depth) with reference to FIGS. 2 to 9. First, the flowchart of FIG. 2 shows the content of the control by the information control circuit 3.

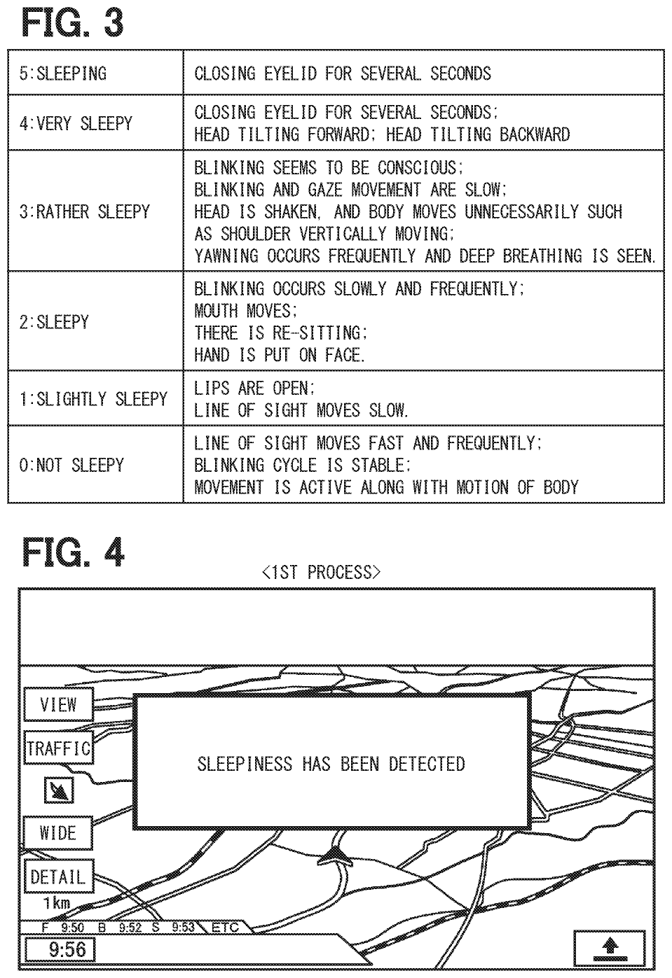

In step S10 of FIG. 2, the risk controller 9 functioning the sleepiness depth detector receives information from the DSM vehicle-inside camera 12, information from the DSM data controller 8, and calculates the driver's sleepiness depth based on the received information. In this case, the sleepiness depth n is defined as a numerical value from 0 to 5, and the definitions are shown in the drawing of FIG. 3.

As shown in FIG. 3, the sleepiness depth 0 is a state in which the driver does not seem to be sleepy at all; in the sleepiness depth 0, the motion of the facial expression of the driver is a motion state in which the movement of the line of sight is fast and frequent, the blinking cycle is stable, and the movement is active along with the motion of the body. The sleepiness depth 1 is a state where the driver seems to be slightly sleepy; in the sleepiness depth 1, the motion of the facial expression of the driver is a motion state in which the lips are open or the line of sight moves slow.

The sleepiness depth 2 is a motion state in which the driver seems to be sleepy; in the sleepiness depth 2, the motion of the facial expression of the driver or the motion of the body of the driver is a motion state in which the blinking occurs slowly and frequently, the mouth moves, there is re-sitting, or the hand is put on the face.

The sleepiness depth 3 is a state in which the driver seems to be rather sleepy; the motion of the facial expression of the driver or the motion of the body of the driver is a motion state in which blinking seems to be conscious, blinking and gaze movement are slow, the head is shaken, the body moves unnecessarily such as the shoulder vertically moving, or yawning occurs frequently and the deep breathing is seen.

The sleepiness depth 4 is a state where the driver is very sleepy; in the sleepiness depth 4, the motion of the facial expression of the driver or the motion of the body of the driver is a motion state in which the eyelid is closed for several seconds, the head is tilting forward, or the head is tilting backward.

The sleepiness depth 5 is a state where the driver is sleeping; in the sleepiness depth 5, the motion of the facial expression of the driver is a motion state in which the eyelid is closed for several seconds. This embodiment provides a configuration in which the sleepiness depth of the driver is detected or determined based on the drawing of FIG. 3 and the information from the vehicle-inside camera 12, such as the image data of the driver's face, body, etc., or the video information captured continuously. The sleepiness depth n is expressed not only by an integer value from 0 to 5, but also by a decimal value obtained by dividing the integer value into 10 equal parts, for instance. In addition, the sleepiness depth n is configured to be set to 6 levels from 0 to 5, but is not limited to this, and may be configured to be set to 3 levels or more or less than 5 levels, or 7 levels or more.

Subsequently, the process proceeds to step S20, and the risk controller 9 transmits the calculation result (i.e., the detected sleepiness depth n) to the HMI controller 15. Subsequently, in step S30, based on the received sleepiness depth n, the HMI controller 15 generates a sleepiness warning advice (i.e., sleepiness warning advice messages as shown in FIGS. 4, 5, and 6). In step S40, the HMI controller 15 transmits the generated sleepiness warning advice message to the information notification device 10.

Thereafter, the process proceeds to step S50, where it is determined whether or not the sleepiness depth n is found as 2≤n<3. In step S50, if the sleepiness depth is 2, that is, if the sleepiness depth is in a low level (YES), the process proceeds to step S60 and a first process is executed. The contents of the first process will be described later. When the execution of the first process is completed, this control is ended.

In step S50, when the sleepiness depth n is not found as 2≤n<3 (NO), the process proceeds to step S70 to determine whether the sleepiness depth n is found as 3≤n<4. If the sleepiness depth is 3 in step S70, that is, if the sleepiness depth is in a medium level (YES), the process proceeds to step S80 and a second process is executed. The contents of the second process will be described later. When the execution of the second process is completed, this control is ended.

In step S70, when the sleepiness depth n is not found as 3≤n<4 (NO), the process proceeds to step S90, where it is determined whether the sleepiness depth n is found as 4≤n. If the sleepiness depth is 4 in step S90, that is, if the sleepiness depth is high (YES), the process proceeds to step S100 and a third process is executed. The contents of the third process will be described later. When the execution of the third process is completed, this control is ended.

In step S90, when the sleepiness depth n is not found as 4≤n, that is, when the sleepiness depth is less than 2, the driver is not likely to be sleepy at all, or is likely to be sleepy a little, so the process proceeds to “NO”. This control is ended without executing anything.

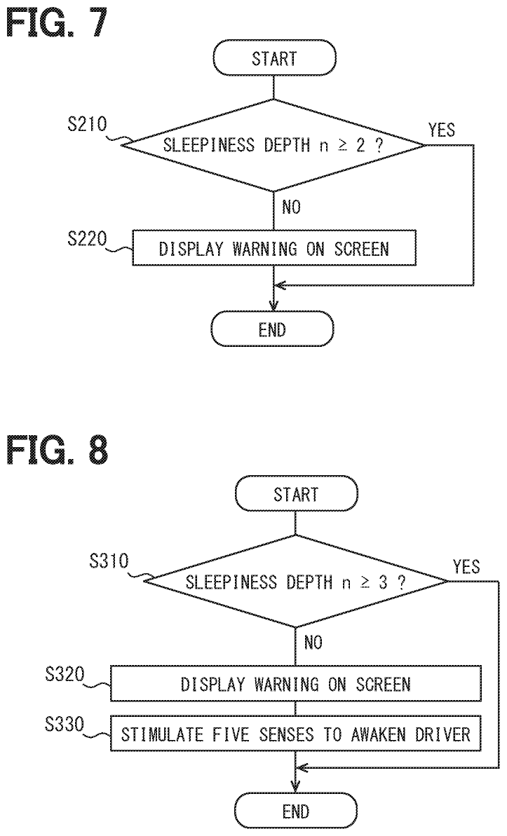

Next, the control of the first process in step S60, that is, the control when the sleepiness depth n is 2 will be described with reference to the flowchart of FIG. 7. FIG. 7 is a flowchart showing the control contents of a subroutine for executing the first process. First, in step S210 of FIG. 7, it is determined whether or not the sleepiness depth n is found as n≥2.

Here, since the sleepiness depth n is 2 (YES), the process proceeds to step S220. In step S220, the information notification device 10 in the information control circuit 3 displays a sleepiness warning advice message, for example, a warning message “sleepiness has been detected” on the display screen, as shown in FIG. 4, to encourage the driver to awaken, for example, to take a break. By visually recognizing this warning message, the driver may try to take a break to wake up.

The passenger sitting in the passenger seat can visually recognize the warning message and thus prompt the driver to take a break. Note that when the execution of step S220 is completed, this control is ended. In step S210, when the sleepiness depth n is less than 2, the process proceeds to “NO” and this control is ended.

Further, the control of the second process in step S80, that is, the control when the sleepiness depth n is 3 will be described with reference to the flowchart of FIG. 8. FIG. 8 is a flowchart showing the control contents of a subroutine for executing the second process. First, in step S310 of FIG. 8, it is determined whether or not the sleepiness depth n is n≥3.

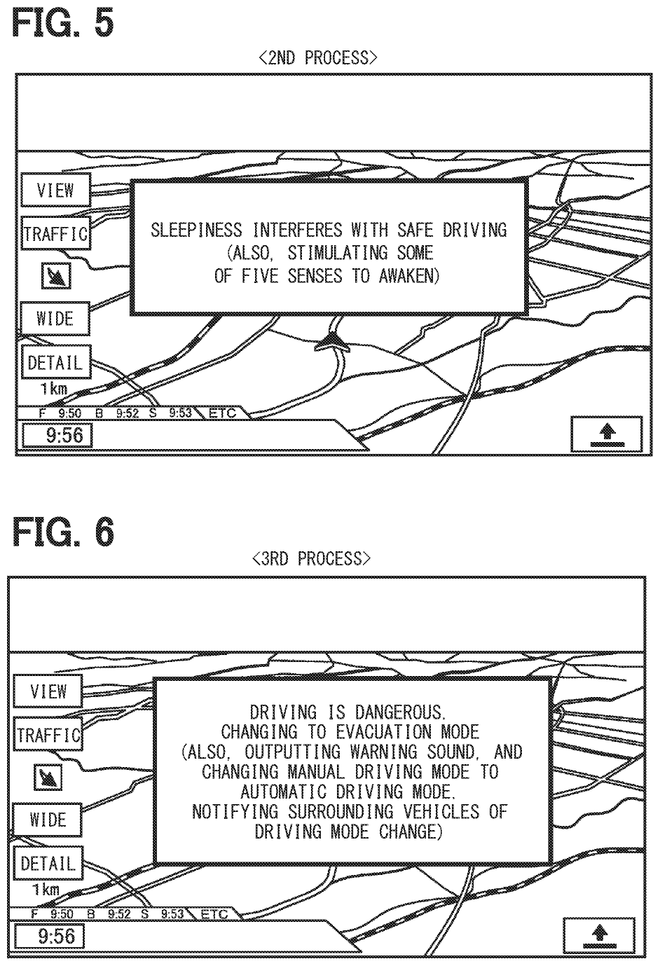

Here, since the sleepiness depth n is 3 (YES), the process proceeds to step S320, and the information notification device 10 in the information control circuit 3 displays a warning message on the display screen as shown in FIG. 5. The message “sleepiness interferes with safe driving (also stimulating some of five senses to awaken)” is displayed. Then, the process proceeds to step S330, where the information control circuit 3 performs the process which stimulates a driver's five senses, and awakens a driver. In this case, the following stimulation is executed as the process which stimulates the five senses.

First, a first stimulation process is to increase the air volume of the air conditioner and thereby lower the skin temperature to wake up. A second stimulation process is to output a loud warning sound or a loud warning speech and promote awakening. In this case, the warning speech is a speech message such as “be careful about driving because the sleepiness depth is high”.

A third stimulation process is to apply a high voltage current to the driver's hand by passing a high voltage current through the steering wheel or the like to stimulate the sense of touch and promote awakening. A fourth stimulation process is to strengthen the seat heater in the driver's seat to give high heat to the driver, that is, to raise the driver's skin temperature and promote awakening. In addition, in the case of a vehicle provided with a seat cooling device, the seat cooling device is strengthened and a cold source is given to the driver. That is, the driver's skin temperature may be lowered to promote awakening. A fifth stimulation process is to generate a stimulating odor from the steering wheel or the like to stimulate the driver's olfaction and promote awakening.

The above five stimulation processes may be configured to be performed in step S330; alternatively, one to four of the five stimulation processes may be appropriately selected and performed.

In this embodiment, when the respective stimulation processes described above are performed and the driver thereby awakens, the driver having received the stimulus is quite surprised. In this case, the driver can visually recognize the warning message displayed on the display to thereby become easy to understand that the stimulation process for promoting the driver's awakening has been performed. The driver can thereby get a sense of security and never be confused. Further, the driver comes to think of taking a break by visually recognizing the warning message. The passenger sitting in the passenger seat can prompt the driver to take a break by visually recognizing the warning message. When the execution of step S330 is completed, this control is ended. In step S310, when the sleepiness depth n is less than 3, the process proceeds to “NO” and this control is ended.

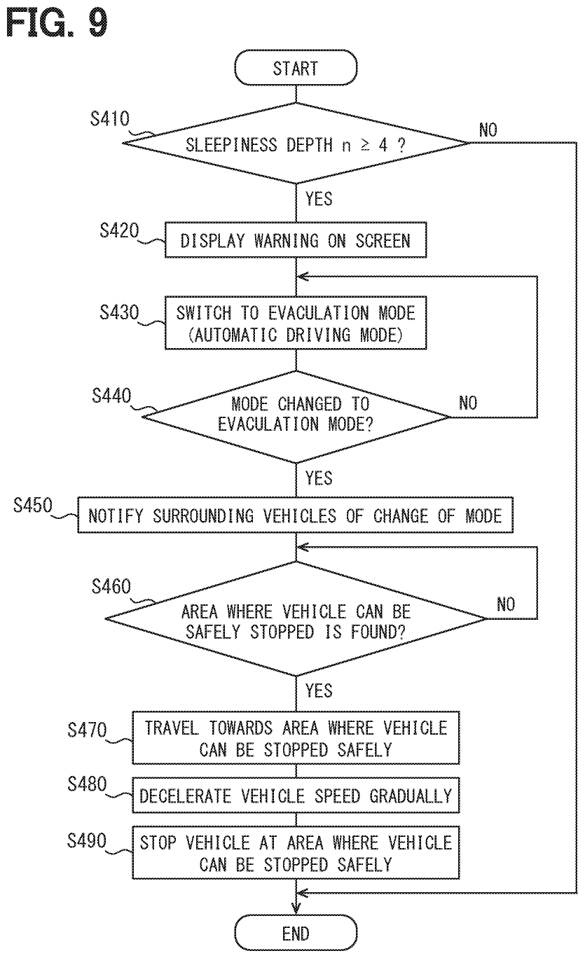

Further, the control of the third process in step S100, that is, the control when the sleepiness depth n is 4, will be described with reference to the flowchart of FIG. 9. FIG. 9 is a flowchart showing the control contents of a subroutine for executing the third process. First, in step S410 of FIG. 9, it is determined whether or not the sleepiness depth n is n≥4.

Here, since the sleepiness depth n is 4 (YES), the process proceeds to step S420, where the information notification device 10 of the information control circuit 3 displays a warning message on the screen of the display as shown in FIG. 6, for example. That is, the message is as follows: “Driving is dangerous. Changing to evacuation mode. (Also, outputting warning sound, and changing manual driving mode to automatic driving mode. Notifying surrounding vehicles of driving mode change.)”

Then, in step S430, the information control circuit 3 switches to the evacuation mode, i.e., automatic driving mode. In this case, the risk controller 9 in the information control circuit 3 transmits instruction information for instructing switching to the automatic driving mode to the vehicle travel controller 7 in the travel control circuit 2. The vehicle travel controller 7 receives the instruction information, switches to the automatic driving mode, and executes the automatic driving. In addition, the vehicle travel controller 7 transmits information indicating that switching to automatic driving is performed to the risk controller 9 in the information control circuit 3.

In step S440, the risk controller 9 in the information control circuit 3 determines whether or not the driving mode has been changed to the evacuation mode, that is, whether or not information indicating that the driving mode has been switched to the automatic operation mode has been received. In step S440, when the mode is changed to the evacuation mode (YES), the process proceeds to step S450. In step S450, the risk controller 9 in the information control circuit 3 transmits (i.e., reports) information indicating that the driving mode has been changed to the evacuation mode, that is, the automatic driving mode, to the surrounding vehicles via the inter-vehicle communication with the communicator 14. If it is determined in step S440 that the driving mode has not been changed to the evacuation mode (NO), the process returns to step S430, and the above-described control is repeatedly executed.

Thereafter, the control from step S460 to step S490 indicates the control after switching to the automatic driving mode, that is, the control by the vehicle travel controller 7 in the travel control circuit 2. First, in step S460, the vehicle travel controller 7 determines whether there is an area (i.e., a point around the current position of the vehicle) where the vehicle can be safely stopped. Here, when there is no area where the vehicle can be safely stopped (NO), the process of step S460 is repeatedly executed.

When there is an area where the vehicle can be safely stopped in step S460, that is, when an area where the vehicle can be safely stopped is found (YES), the process proceeds to step S470. In step S470, the vehicle travel controller 7 travels towards an area where the vehicle can be safely stopped as a destination. In the future, the areas where the vehicle can be safely stopped will also be installed on highways.

Then, in step S480, the vehicle travel controller 7 gradually decelerates a vehicle speed, while driving towards the area where the vehicle can be stopped safely. In step S490, the vehicle travel controller 7 stops the vehicle in the area where the vehicle can be stopped safely. Then, the control is ended. In step S410, when the sleepiness depth n is less than 4, the process proceeds to “NO” and this control is ended.

This embodiment having such a configuration provides a configuration in which: the driver's state is monitored by the vehicle-inside camera 12; the sleepiness depth of the driver is detected by the risk controller 9 based on the monitored state of the driver; and a process corresponding to the detected level of sleepiness depth of the driver is selected and executed from among a plurality of processes for awakening the driver by the information control circuit 3. According to this configuration, when the driver is sleepy, the driver can be surely warned according to the level of sleepiness depth of the driver, that is, the sleepiness level. In addition, the driver can be awakened, and safety can be sufficiently enhanced.

The above embodiment provides by using the information control circuit 3 a configuration in which: when the sleepiness depth is in a low level, a process to display a warning message on the screen is executed; when the sleepiness depth is in a medium level, a process to stimulate the five senses of the driver is executed; and when the sleepiness depth is in a high level, the driving mode is switched to the evacuation mode, and a process to automatically stop the vehicle is executed. According to this configuration, the driver can be awakened, the safety can be increased, or the optimal sleepiness countermeasure can be executed according to the level of the driver's sleepiness depth.

Furthermore, the above embodiment provides a configuration to perform: the control that lowers the skin temperature by increasing the airflow of the air conditioner as a process to stimulate the five senses of the driver; the control that outputs warning sound or warning speech; the control that applies high voltage current to the hand; the control that increases the temperature of the skin by strengthening the seat heater; and the control that generates irritating odor and stimulates olfaction. According to this configuration, when the driver's sleepiness depth is 3, the driver can be awakened by executing the process of stimulating the five senses.

Further, the above embodiment provides a configuration in which when detecting the sleepiness depth, the motion of the facial expression of the driver or the body of the driver is photographed by the vehicle-inside camera 12, and detected in three or more levels based on the photographed image information. According to this configuration, it is possible to select and execute appropriate control according to the level of sleepiness depth from among three or more controls.

In the above embodiment, when the driving mode is switched to the evacuation mode in a vehicle, the information control circuit 3 in the vehicle is configured to notify the surrounding vehicles that the mode has been switched to the evacuation mode. According to this configuration, the surrounding vehicle can clearly recognize a vehicle whose driving mode is switched to the evacuation mode, that is, a vehicle whose driver's sleepiness depth n is 4 or more. The surrounding vehicle can thus pay attention to the driving of the vehicle and improve safety.

### Second Embodiment

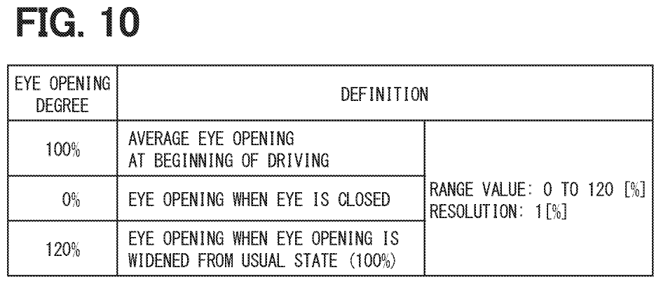

FIG. 10 shows a second embodiment. A configuration identical to that according to the first embodiment is denoted by an identical reference sign. In the first embodiment, the driver's sleepiness depth n is detected, and the driver's sleepiness is determined to be divided into three levels according to the value of the sleepiness depth n. Instead, in the second embodiment, the driver's sleepiness degree is determined in three levels based on the eye opening degree and the eye opening time of the driver's eyes.

First, the definition of the eye opening degree will be described with reference to the drawing of FIG. 10. First, the eye opening degree is defined as the percentage of eye opening that matches the driver's eye shape. As the eye opening degree, a representative value is obtained from (i) each of the left eye and the right eye and (ii) the eye opening degree of each of the left eye and right eye. The eye opening degree representative value is used for eye closing determination and sleepiness determination. The eye opening degree is output with a high resolution of, for example, 1% so that the sensitivity of eye closing determination can be adjusted. In addition, measures have been taken not to make an erroneous determination of closed eyes for a smile or an anti-glare expression. Further, the eye opening degree is normalized, and eye opening degree of 100%, 0%, and 120% are defined as shown in the drawing of FIG. 10.

As shown in FIG. 10, the eye opening degree of 100% is an average eye opening at the beginning of driving; namely, the eye opening degree of 100% is the degree of the eye opening in a usual state. The eye opening degree 0% is the opening degree of the eye in a state where the eye is closed. The eye opening degree of 120% is the degree of the eye opening in a state where the eye opening is further widened from the eye opening degree of 100% (i.e., the eye opening degree in a usual state). The value of range of the eye opening degree is 0 to 120 (%), and the resolution is 1 (%)

In the second embodiment, the determination of the sleepiness degree of the driver is configured to determine (i.e., detect) the following three levels of level 1, level 2, and level 3 based on the eye opening degree and the eye opening time. First, the level 1 of sleepiness degree is determined as follows. For example, suppose a case where (i) an event of an eye opening degree of 0% continues for a period of 1 to 2 seconds, and (ii) that event occurs repeatedly two times or more within 30 seconds. In such a case, it is determined that the sleepiness degree is level 1.

Further, the level 2 of sleepiness degree is determined as follows. For example, suppose a case where (i) an event of an eye opening degree of 0% continues for a period of about 2 seconds, and (ii) that event occurs at least one time. In such a case, it is determined that the sleepiness degree is level 2. Also, the level 3 of sleepiness degree is determined as follows. For example, suppose a case where (i) an event of an eye opening degree of 0% continues for a period of about 4 seconds, and (ii) that event occurs at least one time. In such a case, it is determined that the sleepiness degree is level 3.

When it is determined that the driver's sleepiness degree is level 1, the first process described in the first embodiment is executed. Further, when it is determined that the driver's sleepiness degree is level 2, the second process described in the first embodiment is executed. Further, when it is determined that the driver's sleepiness degree is level 3, the third process described in the first embodiment is executed.

The configurations of the second embodiment other than those described above are the same as the configurations of the first embodiment. The second embodiment thus achieves functional effect substantially same as that according to the first embodiment.

Moreover, in each of the above embodiments, although the driver's sleepiness degree might be divided and determined in three levels, there is no need to be limited to this. It may be determined in two levels or four levels or more.

Further, in each of the above embodiments, the DSM data controller 8 is provided on the side of the vehicle travel control circuit 2. Instead, the DSM data controller 8 may be provided on side of the information control circuit 3.

Although the present disclosure is described based on the above embodiments, the present disclosure is not limited to the embodiments and their configurations. The present disclosure encompasses various modification examples and variations within the scope of equivalents. In addition, various combinations and forms, and further, other combinations and forms including only one element, or more or less than these elements are also within the spirit and the scope of the present disclosure.

For reference to further explain features of the present disclosure, the description is added as follows.

There is known a system that recognizes a driver's image captured with an in-vehicle camera, determines the driver's sleepiness, and generate a sound and vibration when the driver's sleepiness becomes strong, thereby encouraging awakening.

However, in such a known configuration, the driver may be awakened by sound or vibration, but the driver may not be awakened only by sound or vibration. Thus it cannot be said that the safety is sufficient. Also, even if sound or vibration is generated, the driver may not recognize what has happened, and the driver may not know how to respond and may be confused.

It is thus desired to provide a vehicle driving assistance apparatus which can be sure to warn the driver who is sleepy and awaken the driver, thereby increasing safety in driving sufficiently.

Aspects of the present disclosure described herein are set forth in the following clauses.

According to a first aspect of the present disclosure, a vehicle driving assistance apparatus is provided to include a driver monitor, a sleepiness detector, and a control circuit. The driver monitor monitors the driver state. The sleepiness detector is configured to detect the sleepiness depth of the driver or the sleepiness degree of the driver based on the monitored state of the driver. The control circuit is configured to select and execute a process corresponding to one of a plurality of levels of the detected sleepiness depth of the driver or a level of the detected sleepiness degree of the driver from among a plurality of processes for awakening the driver.

Further, according to a second aspect of the present disclosure, a vehicle driving assistance apparatus is provided to include a sleepiness detector and a control circuit. The sleepiness detector is configured to detect a sleepiness degree of a driver in a vehicle based on an eye opening degree and an eye opening time of an eye of the driver. The control circuit is configured to select and execute a process corresponding to one of a plurality of levels of the detected sleepiness degree from among a plurality of processes to awaken the driver.

Further, the driver monitor may be provided as a camera configured to capture an image of the driver. The sleepiness detector and/or the control circuit may be provided as one or more controllers (which may also referred to as one or more processors). Herein, an individual one of the one or more controllers may be configured by (i) a central processing unit (CPU) along with memory storing instructions executed by the CPU or (ii) hardware circuitry including an analog circuit and/or digital circuit with no CPU, or (iii) a combination of the CPU along with memory and the hardware circuitry.

What is claimed is:

1. A vehicle driving assistance apparatus comprising:
a sleepiness detector configured to detect a sleepiness degree of a driver in a vehicle based on an eye opening degree and an eye opening time of an eye of the driver; and
a control circuit configured to select and execute a process corresponding to one of a plurality of levels of the detected sleepiness degree from among a plurality of processes to awaken the driver.

2. The vehicle driving assistance apparatus according to claim 1, wherein:
in response to the sleepiness degree being in a low level, the control circuit is configured to execute a process of displaying a warning message on a screen;
in response to the sleepiness degree being in a medium level, the control circuit is configured to execute a process of stimulating five senses of the driver; and
in response to the sleepiness degree being in a high level, the control circuit is configured to switch a driving mode to an evacuation mode, and execute a process of automatically stopping the vehicle.

3. The vehicle driving assistance apparatus according to claim 1, wherein
a process of stimulating five senses of the driver includes
a control of lowering a skin temperature of the driver by increasing an airflow of an air conditioner,
a control of outputting a warning sound or a warning speech,
a control of applying a high voltage current to a hand of the driver,
a control of increasing a skin temperature of the driver by strengthening a seat heater, or
a control of stimulating a sense of smell by generating a pungent odor.

4. The vehicle driving assistance apparatus according to claim 1, wherein
the sleepiness degree is detected in three levels or more levels based on image information, which is captured by a camera configured to photograph a motion of a facial expression of the driver or a motion of a body of the driver.

5. The vehicle driving assistance apparatus according to claim 2, wherein
in response to switching the driving mode to the evacuation mode, the control circuit is configured to notify a surrounding vehicle of switching to the evacuation mode.

6. A vehicle driving assistance apparatus comprising:
a camera provided in a vehicle and configured to capture an image of a driver in the vehicle; and
one or more controllers connected with the camera via a communication link in the vehicle,
the one or more controllers being configured to:
calculate an eye opening degree and an eye opening time of an eye of the driver based on the image of the driver captured by the camera;
determine a determined level among a plurality of levels of a sleepiness degree of the driver based on the calculated eye opening degree and the calculated eye opening time of the eye of the driver;
select a selected process among a plurality of processes to awaken the driver according to the determined level of the sleepiness degree; and
execute the selected process according to the determined level of the sleepiness degree.
